(19) United States
(12) Patent Application Publication
(10) Pub. No.: US 2015/0355656 A1
(43) Pub. Date: Dec. 10, 2015

(54) ELECTRIC APPLIANCE STANDBY ELECTRICITY-SAVING CONTROL DEVICE

(71) Applicant: SGET CORP., Apia Samoa (WS)

(72) Inventors: RONNIE TSIN LEE LAI, NEW TAIPEI CITY (TW); CHIH-HONG CHEN, NEW TAIPEI CITY (TW); JENNY ING NGU, NEW TAIPEI CITY (TW)

(21) Appl. No.: 14/708,393

(22) Filed: May 11, 2015

(30) Foreign Application Priority Data
Jun. 4, 2014 (TW) 103209787

(51) Int. Cl. G05F 1/66; G05B 15/02

(52) U.S. Cl. CPC G05F 1/66; G05B 15/02

(57) ABSTRACT

An electric appliance standby electricity-saving control device includes an electricity-saving message access interface and an electricity-saving message storage device. The electricity-saving message storage device stores therein an electricity-saving message. A reading device is allowed to read, through the electricity-saving message access interface and with a predetermined communication protocol, the electricity-saving message stored in the electricity-saving message storage device. The electricity-saving message access interface is one of a radio frequency communication interface, a Wifi communication interface, a Bluetooth communication interface, and a plug-in transmission interface.

### BACKGROUND OF THE INVENTION

1. Field of the Invention

The present invention relates to an electric appliance standby electricity-saving control device, and in particular for an electric appliance standby electricity-saving control device that stores electricity-saving related data.

2. The Related Arts

The development of electronic technology has been increasingly mature and all sorts of electric device are now necessary to support people lifestyles worldwide. To just name some. these electric devices can be as small as household or office electric appliances, such as televisions, video consoles, computers, refrigerators, air conditioners, microwave ovens, and printers, or as large as bulky machines that are commonly used in laboratories and workshops, such as super computer. For easy and immediate use of these devices, when devices are not in operating mode, users usually keep them in a standby mode, wherein the connection between the electric device and a power source is not cut off. In this mode, the electric device continues to consume a small amount of electric power, widely known as standby power.

The current trend of using electric devices is to use in a power saving manner and the “electricity-saving” modes of most of the electric devices are conducted when the devices are in an activated condition. This is good progress as standby power losses by an electric device has long been neglected and on a worldwide basis. Although the power consumed by each individual electric device in the standby mode may seem small in quantity, the sum of the total standby power losses of a large number of electric devices can be quite huge. This is not just a waste of energy but also causes an unnecessary increase in utility expenses and is generally contrary to the current trend of achieving energy savings.

Electricity rates are generally increasing worldwide and most people have responded positively and do their best to reduce power consumption. Various sorts of electricity-saving devices are now available in the market. However, a user of any such electricity-saving devices, when used in conjunction with an electric appliance, has no way to access any information regarding electricity-savings or factually know how much power has been saved with such known electricity-saving devices and likewise has absolutely no idea if the electricity-saving devices being used can actually help save any electric power at all. It is as such not surprising that fraudulent claims are often fabricated by manufacturers and consumers in turn deceived and induced to purchase energy saving devices that are either of poor performance or do not work at all.

In order to encourage consumers to install electricity-saving devices for energy saving and in turn achieve carbon reduction whilst actually achieving electricity-savings, it is a necessity that the industry must devote themselves to development and research in order to solve an everyday common problem for all users of electric devices.

### SUMMARY OF THE INVENTION

In view of these issues and challenges, an object of the present invention is to provide an electric appliance standby electricity-saving control device, in which the amount of electric power saved is calculated by the electricity-saving device and a reading device is used to access, with a predetermined communication protocol, an electricity-saving message stored in an electricity-saving message storage device through an electricity-saving message interface for statistics and recordation.

The technical solution that is adopted in the present invention to achieve the above objectives comprises of an electric appliance standby electricity-saving control device connected between a power source and an electric appliance. The electric appliance standby electricity-saving control device comprises an electricity-saving message access interface and an electricity-saving message storage device, wherein the electricity-saving message storage device stores an electricity-saving message. A reading device is allowed to read, through the electricity-saving message access interface and with a predetermined communication protocol, the electricity-saving message stored in the electricity-saving message storage device.

The electricity-saving message access interface can be one of a radio frequency communication interface, a Wifi communication interface, and a Bluetooth communication interface and can also be a plug-in transmission interface.

The electric appliance standby electricity-saving control device may comprise of a pluggable data storage device to store the electricity-saving message.

For full effectiveness, the above-described technical solution adopted in the present invention allows the electric power that is saved to be read clearly for subsequent statistics and recordation. And, the electricity-saving message can be transmitted easily to thereby provide an integrated electricity-saving encouraging mechanism that effectively encourages the general consumers to install the electricity-saving device to achieve energy saving, subsequent carbon reduction and the intent of saving energy and power savings can be quantified.

### BRIEF DESCRIPTION OF THE DRAWINGS

The present invention will be apparent to those skilled in the art by reading the following description of preferred embodiments of the present invention, with reference to the attached drawings, in which:

FIG. 1 is a circuit diagram showing an electric appliance standby electricity-saving device according to the present invention connected between a power source and an electric appliance;

FIG. 2 shows a control circuit of an electric appliance standby electricity-saving device according to a first embodiment of the present invention;

FIG. 3 shows a control circuit of a reading device according to the present invention; and

FIG. 4 shows a control circuit of an electric appliance standby electricity-saving device according to a second embodiment of the present invention.

### DETAILED DESCRIPTION OF THE PREFERRED EMBODIMENTS

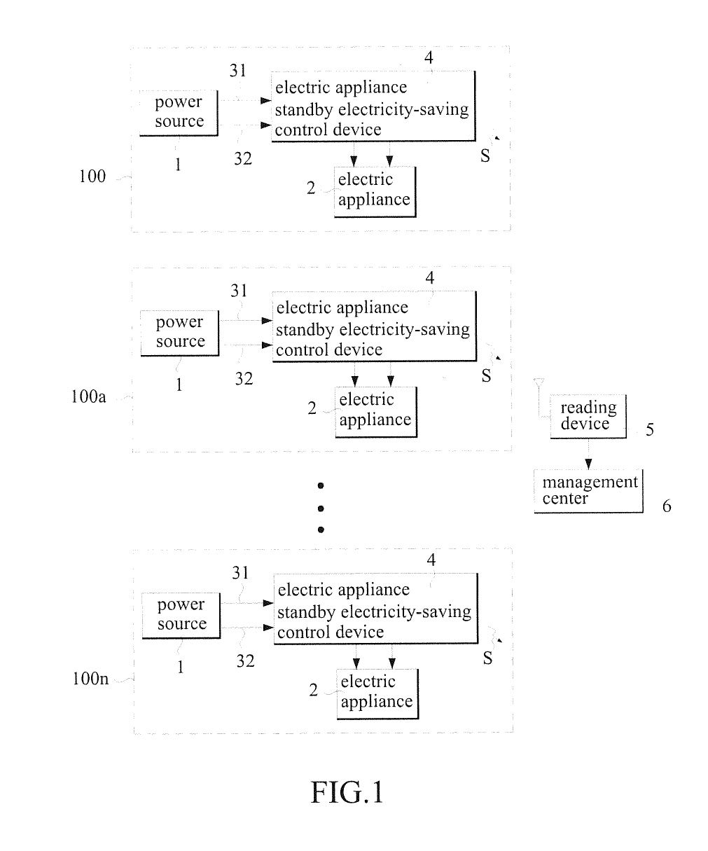

With reference to the drawings and in particular to FIG. 1, an electric appliance standby electricity-saving control device 4 is installed in power supply circuits 31, 32 between a power source 1 and an electric appliance 2 of each of a plurality of users 100, 100a, . . . 100n. Each of the electric appliance standby electricity-saving control devices 4 provides an electricity-saving message S that is accessible with a reading device 5. The reading device 5 also functions to collect and transmit the electricity-saving message S that is read from the electric appliance standby electricity-saving control device 4 of each of the users 100, 100a, . . . , 100n to a management center 6 in a wired or warless manner or through Internet or local area networks. Each of the electric appliance standby electricity-saving control devices 4 is designated with a unique identification code so that the reading device 5, when performing reading operations, may identify the electric appliance standby electricity-saving control devices 4 of different users.

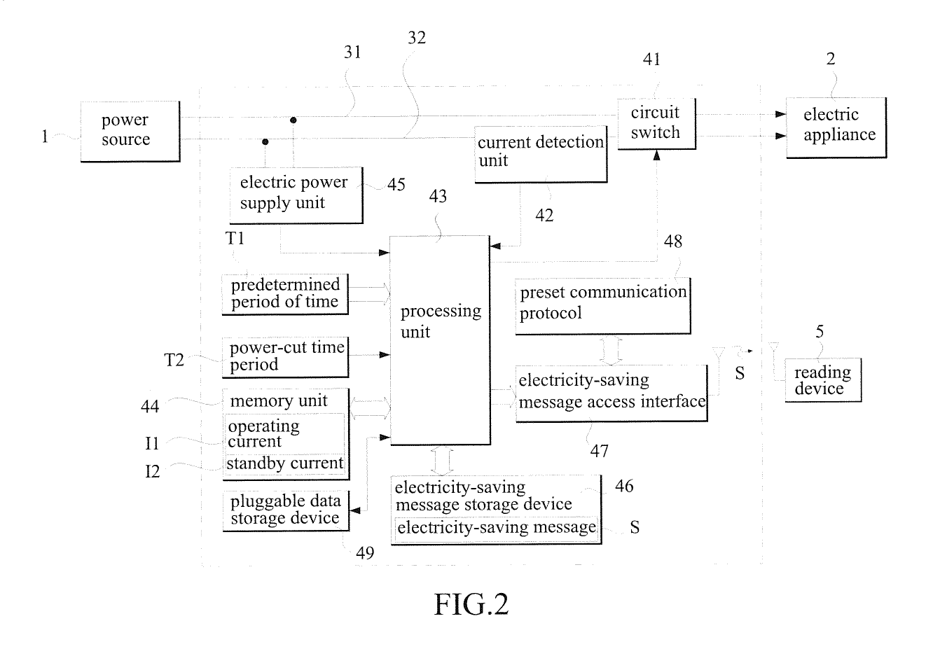

FIG. 2 shows a control circuit diagram of an electric appliance standby electricity-saving control device 4 according to a first embodiment of the present invention, wherein the electric appliance standby electricity-saving control device 4 comprises a circuit switch 41, a current detection unit 42, a processing unit 43, a memory unit 44, an electric power supply unit 45, an electricity-saving message storage device 46, and an electricity-saving message access interface 47.

The circuit switch 41 is mounted in the power supply circuits 31, 32. The electric appliance 2 has an operating mode, a standby mode, and a power-off mode. The electric current that flows through the power supply circuits 31, 32 in the operating mode is defined as an operating current 11, while the electric current that flows through the power supply circuits 31, 32 in the standby mode is defined as a standby current 12.

The current detection unit 42 is connected to the power supply circuits 31, 32 to detect the operating current 11 and the standby current 12 flowing through the power supply circuits 31, 32. The processing unit 43 stores the operating current 11 and the standby current 12 so detected in the memory unit 44.

The electric power supply unit 45 is connected to the power supply circuits 31, 32 to supply electric power to the processing unit 43. After the processing unit 4 identifies the electric appliance 2 has been in the standby mode for a predetermined period of time T1, the processing unit 43 controls the circuit switch 41 to open, making the electric appliance 2 enter the power-off mode.

When the circuit switch 41 is in an open condition, the processing unit 43 detects, at the time when the electric appliance 2 resumes operating in the operating mode, a time period T2 within which power is cut and performs calculation according to the power-cut time period T2 and the standby current 12 to generate an electricity-saving message S and stores the electricity-saving message S in the electricity-saving message storage device 46.

The electricity-saving message storage device 46 and the electricity-saving message access interface 47 are connected to the processing unit 43. The electricity-saving message access interface 47 can be one of a radio frequency communication interface, a Wifi communication interface. and a Bluetooth communication interface. A preset communication protocol 48 is provided, according to the type of interface used so that the reading device 5 that is provided with the same preset communication protocol is allowed to read, through the electricity-saving message access interface 47, the electricity-saving message S stored in the electricity-saving message storage device 46.

The electric appliance standby electricity-saving control device 4 may also comprise a pluggable data storage device 49, which is connected to the processing unit 43 to store the electricity-saving message S. A user may connect, through plugging, the pluggable data storage device 49 to the processing unit 43 or remove it from the processing unit 43.

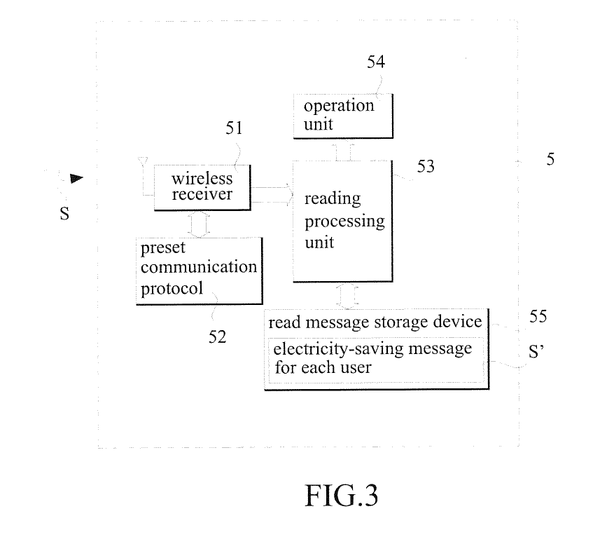

FIG. 3 shows a control circuit diagram of the reading device 5 according to the present invention. The reading device 5 comprises a wireless receiver 51, a preset communication protocol 52, a reading processing unit 53, an operation unit 54, and a read message storage device 55. The reading device 5 is allowed to read the electricity-saving message S that is stored in the electricity-saving message storage device 46 of each of the electric appliance standby electricity-saving control devices 4 by using the wireless receiver 51 through identical communication protocol preset in the electricity-saving message access interface 47 of the electric appliance standby electricity-saving control device 4 of the user for collection and storage in the read message storage device 55 to form an electricity-saving message S′ for each user.

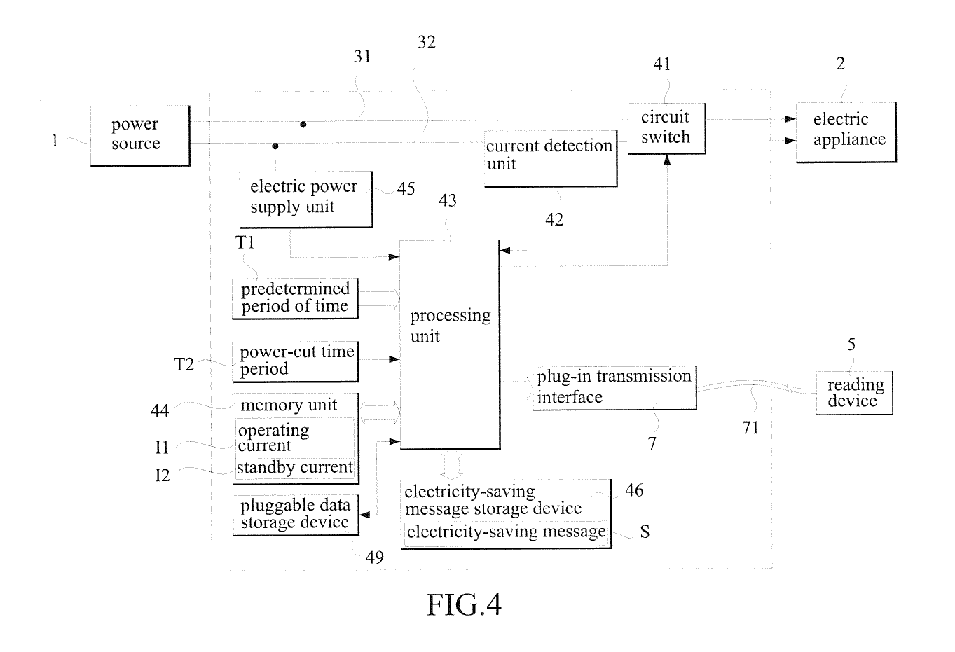

FIG. 4 shows a control circuit diagram of an electric appliance standby electricity-saving device according to a second embodiment of the present invention. The instant embodiment comprises constituent components that are substantially similar to those of the first embodiment so that identical reference numerals are used to designate identical components for consistency. In the instant embodiment, the processing unit 43 is connected to a plug-in transmission interface 7, so that the reading device 5 can read, through a transmission cable 71, the electricity-saving message S stored in the electricity-saving message storage device 46.

Although the present invention has been described with reference to the preferred embodiments thereof, it is apparent to those skilled in the art that a variety of modifications and changes may be made without departing from the scope of' the present invention which is intended to be defined by the appended claims.

What is claimed is:

1. An electric appliance standby electricity-saving control device, which is connected to power supply circuits between a power source and an electric appliance, the electric appliance standby electricity-saving control device comprising:
a circuit switch, which is connected to the power supply circuits between the power source and the electric appliance, wherein the electric appliance has an operating mode, a standby mode, and a power-off mode, and the electric current flowing through the power supply circuits in the operating mode is defined as an operating current, while the electric current flowing through the power supply circuits in the standby mode is defined as a standby current;
a current detection unit, which is connected to the power supply circuits to detect the operating current and the standby current flowing through the power supply circuits;
a processing unit;
a memory unit, which is connected to the processing unit, the memory unit storing therein the operating current and the standby current; and
an electric power supply unit, which is connected to the power supply circuits to supply electric power to the processing unit;
wherein after the processing unit identifies the electric appliance has been in the standby mode for a predetermined period of time, the processing unit controls the circuit switch to open, making the electric appliance enter the power-off mode; and
wherein when the circuit switch is in an open condition, the processing unit detects, at the time when the electric appliance resumes operating in the operating mode, a time period within which power is cut and performs calculation according to the power-cut time period and the standby current to generate an electricity-saving message and stores the electricity-saving message in the electricity-saving message storage device;
the electric appliance standby electricity-saving control device further comprising:
an electricity-saving message storage device, which is connected to the processing unit to store the electricity-saving message; and
an electricity-saving message access interface, which is connected to the processing unit to allow a reading device to read, through the electricity-saving message access interface and with a predetermined communication protocol, the electricity-saving message stored in the electricity-saving message storage device.

2. The electric appliance standby electricity-saving control device as claimed in claim 1, wherein the electricity-saving message access interface is one of a radio frequency communication interface, a Wifi communication interface, and a Bluetooth communication interface.

3. The electric appliance standby electricity-saving control device as claimed in claim 1, wherein the electricity-saving message access interface comprises a plug-in transmission interface.

4. The electric appliance standby electricity-saving control device as claimed in claim 1, wherein the electric appliance standby electricity-saving control device comprises a pluggable data storage device, which is connected to the processing unit to store the electricity-saving message.
